(19) United States
(12) Patent Application Publication
(10) Pub. No.: US 2005/0186383 A1
(43) Pub. Date: Aug. 25, 2005

(54) Colour coding labelling device

(76) Inventor: James Parker Kennedy, Rosemarkie (GB)

Correspondence Address: JAMES PARKER KENNEDY, ONE YOUNG COURT, ROSEMARKIE, IV10 8UY, GB

(21) Appl. No.: 10/784,839

(22) Filed: Feb. 21, 2004

(51) Int. Cl. B32B 3/02

(52) U.S. Cl. 428/68; 428/67

(57) ABSTRACT

This invention relates to a colour coding, labelling device which may be inserted into and permanently bonded to a wood or wood based compound substrate, surface or object by means of adhesives.

The colour coding labelling device, hereinafter referred to as the device, can be used in almost any situation where a durable, waterproof label is required on a wooden or wood based compound substrate, surface or object. From the transport industry, where it can impart information by means of printed, engraved or moulded text, colour, shape, design or any combination of these, eg to brand and grade pallets, to the food industry where it is desirable that chopping blocks and cutting surfaces be colour coded according to their use, it can be employed to good effect.

It can be of any shape on plan ie the visible, readable, exposed surface can be round, square, rectangular, in fact of any geometric or organic shape and of any colour.

A good example of the device's utility is in the food industry, The now more commonly used plastic cutting surfaces are easily colour coded during the manufacturing process but once cut or scored can be difficult to sterilise. Plastics are also disadvantageous in that there is a large hidden environmental cost in both the manufacturing process and disposal.

Traditional wooden cutting boards which have excellent working characteristics, come from a constantly renewable natural resource and present no disposal problems but are difficult to colour code because there seem to be no suitable non toxic adhesives which will bond food grade plastics to wood satisfactorily.

The device as described hereunder overcomes this difficulty.

The device comprises two parts, one thermoplastic injection moulding hereinafter referred to as the “cap” and one wooden or wood based compound insert referred to as the “plug”.

For the purposes of this illustration the cap described will be round on plan that is the surface or exposed face will be circular.

The Cap

The cap resembles one such as might be found on a small jar.

After the plug has been inserted into the cap, the cap is set in the board with the top, flat surface set flush with that of the board.

The colour of the cap indicates the coding of the board and if used also as a branding label may bear a logo, name or any other information desired.

The cap has no internal thread but has a small lip or return set at 90 degrees to the inside of the sidewall of the cap and running continuously around the inside diameter appearing as a small L shape in section profile.

The sidewall of the cap is divided by cuts sufficient in depth and number to permit the cap to flex thus allowing the insertion of the plug. The number and depth of the cuts is governed by the hardness and flexibility of the plastic moulding.

The Plug

The wooden or wood based compound plug is shaped to fill the void of the cap and has a small step to accommodate the L shaped lip or return situated on the inner rim of the cap sidewall.

Assembly of the device.

The plug is pushed into and is encased by the plastic cap this being enabled by the cuts which permit the sidewall to deflect and accommodate the plug. Once the plug is fully inserted the sidewall returns to the original shape and the plug is mechanically retained within the cap by the L shaped lip or return.

The now fully assembled device presents as a disc having one face and edge of plastic and a reverse face of wood or wood based compound held in place by a surrounding rim of plastic. The reverse face now offers a surface compatible with the board or substrate and can be bonded to the bottom of a suitable socket routed or drilled in the board. Adhesive is applied to the bottom of the socket and the device inserted.

Once a bond has been achieved the device is permanently fixed. The lip or return of the cap is held by the plug and since it is contained by the board the sidewall cannot flex to disengage.

A specification of the device and detail of assembly and fixing follows with reference to the accompanying drawing which illustrates:-

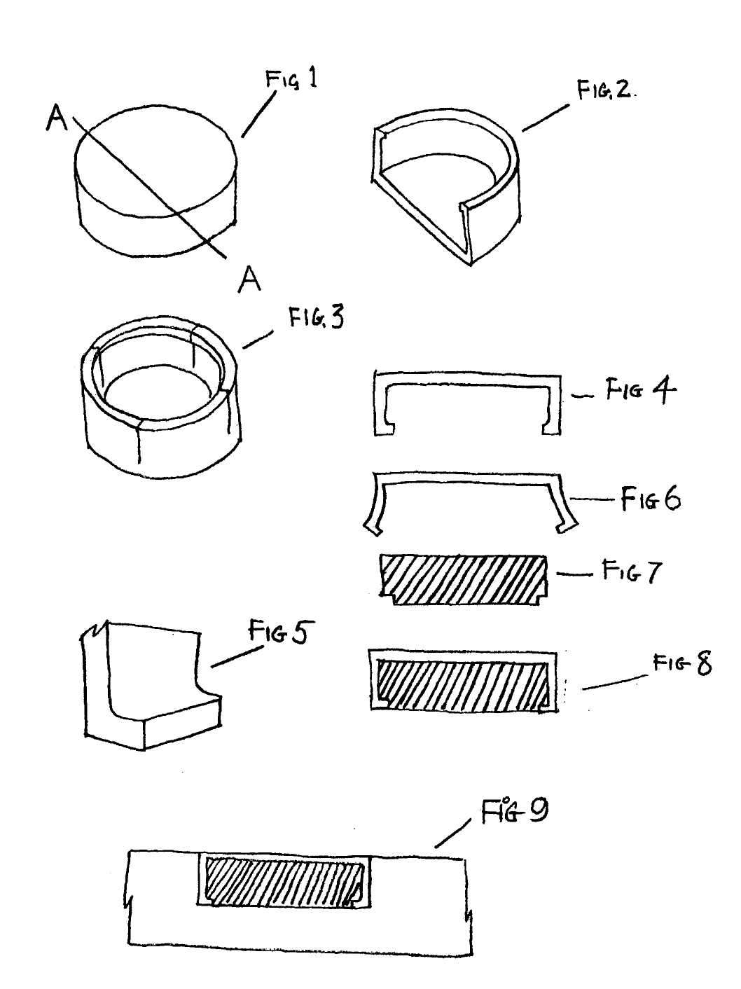

FIG. 1 section A-A taken through the cap.

FIG. 2 isometric view of section A-A taken in FIG. 1

FIG. 3 vertical cuts in wall of cap to allow deflection

FIG. 4 section across diameter of cap

FIG. 5 enlarged detail of lip or return on cap

FIG. 6 cap wall flexed to accommodate plug

FIG. 7 section of plug

FIG. 8 plug encased by cap and retained by lip or return

FIG. 9 assembled device inserted and bonded to substrate

### MATERIALS SPECIFICATION

| | |
|---|---|
| Cap | food grade, polyethylene/polypropylene |
| | non food use any other suitable plastic |
| Plug | natural wood or wood based compound |
| Adhesive | waterproof suitable for indirect food use |
| | non food use any suitable adhesive |

The wooden plug FIG. 7 is pushed into and is encased FIG. 8 by the cap FIG. 4 this being enabled by the cuts shown FIG. 3 permitting the wall of the cap to flex FIG. 6. The wall of the cap having returned to the original shape the lip or return FIG. 5 retains the plug mechanically within the cap.

The completed device may now be bonded to the bottom of a suitable socket in the substrate where the device is secured by the adhesive.

1. A colour coding labelling device comprising a coloured plastic cap, the cap including an upper plate and a sidewall extending downwardly from the perimeter of the plate, and a wood or wood compound plug substantially filling the cavity defined by the upper plate and sidewall, the plug being retained within the cavity by a formation extending around the bottom edge of the sidewall and the bottom face of the plug surrounded by the formation being exposed so that it can be adhered to the base of a socket in an object to be labelled.

2. A device as claimed in claim 1, wherein the formation is a lip or return which engages a shoulder adjacent to the bottom face of the plug.

3. A device as claimed in claim 1 or 2, wherein cuts extend upwardly from the bottom edge of the sidewall permitting the sidewall to flex thereby allowing insertion of the plug.

4. A device as claimed in any preceding claim, wherein the upper plate of the cap carries printed, engraved or moulded text and/or shape and/or other design.

5. A combination of an object having a socket formed in its surface and a device as claimed in any preceding claim secured in the socket by adhesive.

6. A combination as claimed in claim 5, wherein the device as claimed in claim 2 and the wall of the socket contains the sidewall of the cap and prevents the lip or return from disengaging from the plug.

7. A combination as claimed in claim 5 or 6 wherein the object is formed of wood or wood compound.

8. A combination as claimed in claim 7 wherein the object is a cutting board or chopping block as used in food preparation or any object made of wood or wood compound.
